(19) United States
(12) Patent Application Publication
(10) Pub. No.: US 2010/0240860 A1
(43) Pub. Date: Sep. 23, 2010

(54) NATURAL OIL-DERIVED POLYESTER POLYOLS AND POLYURETHANES MADE THEREFROM

(75) Inventors: Timothy Walter Abraham, Minnetonka, MN (US); Jeff J. Malsam, Minneapolis, MN (US)

Correspondence Address: CARGILL, INCORPORATED, P.O. Box 5624, MINNEAPOLIS, MN, 55440-5624, US

(73) Assignee: CARGILL, INCORPORATED, Wayzata, MN (US)

(21) Appl. No.: 12/740,613

(22) PCT Filed: Oct. 31, 2008
(86) PCT No.: PCT/US08/12378

§ 371 Date: Apr. 29, 2010

(30) Foreign Application Priority Data
Nov. 1, 2007 (US) 61001396

(51) Int. Cl. C08G 63/06

(52) U.S. Cl. 528/361

(57) ABSTRACT

A polyester polyol made from natural oil feedstocks is disclosed. Methods for making the polyol are also disclosed. The method comprises reacting monohydroxylated fatty acid/alkyl esters with a multifunctional ester-reactive initiator compound to form the polyester polyol. In one embodiment, the monohydroxylated fatty acid/alkyl esters are made by hydroxylating fatty acid/alkyl esters having greater than about ninety-five percent by weight monounsaturation.

### CROSS REFERENCE TO RELATED APPLICATION

This application claims the benefit of U.S. provisional application Ser. No. 61/001,396 entitled NATURAL OIL-DERIVED POLYESTER POLYOLS AND POLYURETHANES MADE THEREFROM, filed Nov. 1, 2007, which is hereby incorporated by reference in its entirety.

### FIELD

This invention relates to polyester polyols that are derived from natural sources such as vegetable oils.

### BACKGROUND

Polyols are generally produced from petroleum. Polyols are useful in a variety of applications, as polyols may be used in coatings, adhesives, sealants, elastomers, resins and foams. Polyols may be used in a wide variety of fields including the textile, plastic, medical, chemical, manufacturing, and cosmetic industries.

Research in recent years has focused on alternative, non-petroleum based sources of polyols. One area of focus has been the production of polyols from natural oils, with vegetable oils being of particular focus.

Some examples of non-petroleum based polyols include those described by Petrovic et al. in U.S. Pat. Nos. 6,107,433, 6,433,121, 6,573,354, and 6,686,435. Other examples include those described by Kurth in U.S. Pat. No. 6,180,686.

Although the aforementioned polyols are useful in the production of polymers such as polyurethanes, improved non-petroleum based polyols are also desired. In particular, the ability to control the molecular weight and functionality of the non-petroleum based polyol is desirable.

### SUMMARY

The invention relates to polyester polyols that are derived from natural oils and to polymers (e.g., polyurethane foams) that are made therefrom.

In one aspect, the invention provides polyester polyols according to the structure below.

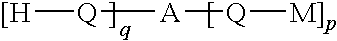

where:
A is residue of a multifunctional ester-reactive initiator compound;
p is ≧1;
q is ≧0;
(p+q) is 2 or greater;
-Q- is independently —O— or

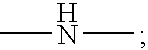

at least 95% by weight of M is selected from:

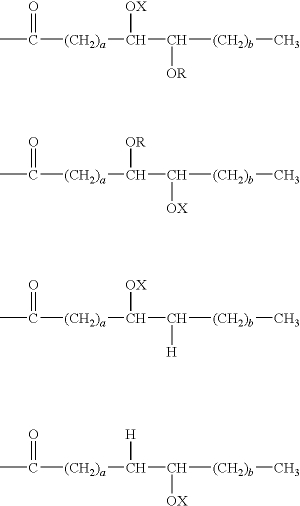

a is >0, more typically 1 to 11;

b is ≧0, more typically 1 to 13;

X is H or M; and

R is a straight or branched chain alkyl group, for example, methyl, ethyl, propyl, butyl, and the like.

In another aspect, the polyester polyols are prepared by a process that comprises the steps of:

(a) providing a composition comprising greater than about 95% weight of a monounsaturated fatty acid/alkyl ester;

(b) epoxidizing at least a portion of carbon-carbon double bonds in the monounsaturated fatty acid/alkyl ester to form a monoepoxidized fatty acid/alkyl ester;

(c) reacting the monoepoxidized fatty acid/alkyl ester with an alcohol or hydrogen to ring-open at least a portion of the epoxide groups to form a composition comprising a monohydroxylated fatty acid/alkyl ester; and

(d) reacting the monohydroxylated fatty acid/alkyl esters with a multifunctional ester-reactive initiator compound according to the formula

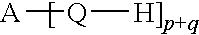

where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines

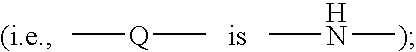

to form the polyester polyol of the invention.

Preferably, the composition comprising greater than 95% by weight of a monounsaturated fatty acid/alkyl ester is produced by transesterifying or hydrolyzing a natural oil to produce a composition comprising monounsaturated fatty acid/alkyl esters, saturated fatty acid/alkyl esters and/or polyunsaturated fatty acid/alkyl esters which are then separated to form the composition comprising greater than 95% by weight of the monounsaturated fatty acid/alkyl ester.

In yet another aspect, the polyester polyols are prepared by a process that comprises the steps of:

(a) providing a composition comprising a monounsaturated fatty acid/alkyl ester;

(b) epoxidizing at least a portion of carbon-carbon double bonds in the monounsaturated fatty acid alkyl ester to form a monoepoxidized fatty acid/alkyl ester;
(c) reacting the monoepoxidized fatty acid/alkyl ester with an alcohol or hydrogen to ring-open at least a portion of the epoxide groups to form a composition comprising a monohydroxylated fatty acid/alkyl ester;

(d) separating the monohydroxylated fatty acid/alkyl ester to form a composition comprising greater than about 95% weight monohydroxylated fatty acid/alkyl ester; and

(e) reacting the monohydroxylated fatty acid/alkyl esters with a multifunctional ester-reactive initiator compound according to the formula

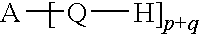

where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines

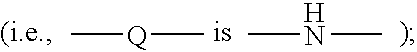

to form the polyester polyol of the invention.

In yet another aspect, the polyester polyols are prepared by a process that comprises the steps of:
(a) providing a natural oil comprising saturated, monounsaturated, and polyunsaturated fatty acids in triglyceride form;
(b) epoxidizing the natural oil to form an epoxidized natural oil;
(c) reacting the epoxidized natural oil with an alcohol or hydrogen to ring-open at least a portion of the epoxide groups to form a composition comprising a hydroxylated natural oil;
(d) transesterifying or hydrolyzing the hydroxylated natural oil to form a composition comprising:
   (i) monohydroxylated fatty acid/alkyl esters; and
   (ii) at least one of:
      saturated fatty acid/alkyl esters and
      polyhydroxylated fatty acid/alkyl esters;
(e) separating the composition of step (d) to provide a composition comprising greater than about 95% weight monohydroxylated fatty acid/alkyl esters; and
(f) reacting the composition comprising greater than about 95% weight monohydroxylated fatty acid/alkyl esters with a multifunctional ester-reactive initiator compound according to the formula

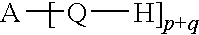

where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines

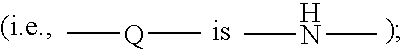

to form the polyester polyol of the invention.

In other preferred aspects, the monounsaturated fatty acid/alkyl esters are fatty acid/alkyl esters derived from: (1) soapstock, (which is a byproduct of refining natural oils); (2) biodiesel production from natural oils; and/or (3) palm oil distillates.

In yet another aspect the invention provides polymers (e.g., polyesters, polyurethanes, and polycarbonates) prepared from the polyester polyols of the invention. In an exemplary embodiment, the polymers are polyurethanes that comprise the reaction product of (a) a polyisocyanate; and (b) a polyester polyol of the invention. The polyurethanes may be polyurethane foams such as flexible slabstock foams or molded foams.

### BRIEF DESCRIPTION OF THE FIGURES

FIG. 1 is an exemplary reaction scheme to produce a polyester polyol of the invention.

FIG. 2 is an exemplary reaction scheme to produce a polyester polyol of the invention.

FIG. 3 is an exemplary reaction scheme to produce a polyester polyol of the invention.

### DETAILED DESCRIPTION

The invention relates to polyester polyols that are derived from natural oils and to polymers (e.g., polyurethanes) that are made therefrom.

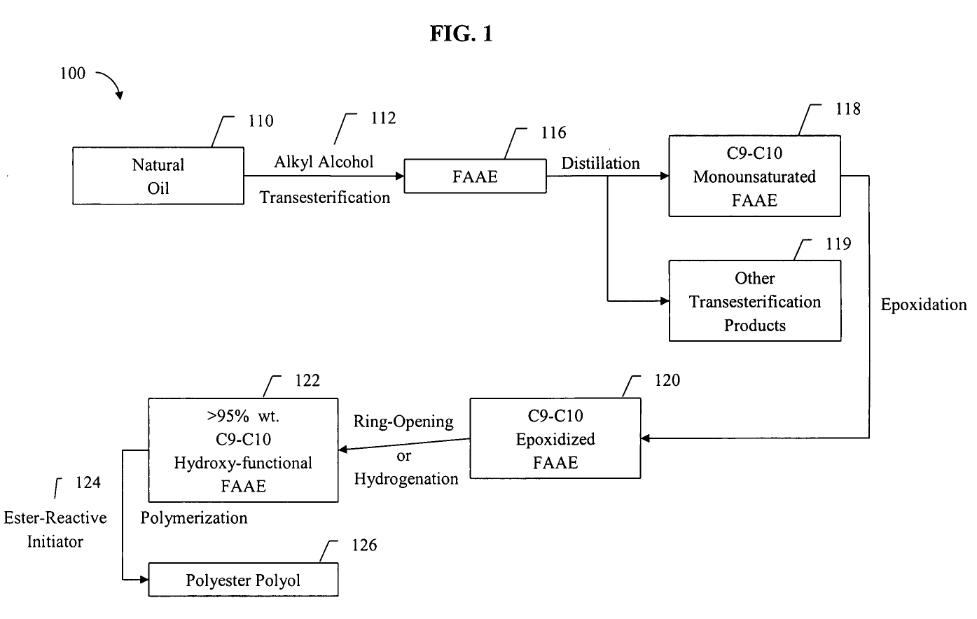

Exemplary methods of making the polyester polyols of the invention will now be described with reference to FIGS. 1-3. For the purpose of the FIGS., C9-C10 monounsaturated fatty acid/alkyl esters (FAAE) are shown and described. However, it is understood that the materials used may also include other monounsaturated fatty acid alkyl esters.

Referring now to FIG. 1, an exemplary reaction scheme 100 for preparing polyester polyols of the invention is provided. In process 100 a natural oil 110 is transesterified with an alkyl alcohol 112 in the presence of a transesterification catalyst 114 to produce a mixture comprising fatty acid alkyl esters 116. The fatty acid alkyl esters 116 are then distilled in order to separate the C9-C10 monounsaturated fatty acid alkyl esters 118 from the remaining transesterification products 119. The separated C9-C10 monounsaturated fatty acid alkyl ester 118 is then epoxidized to form a C9-C10 epoxidized fatty acid alkyl ester 120. By “C9-C10 epoxidized” it is meant that the epoxy oxygen bridges the C9 and C10 carbon atoms in the fatty acid alkyl ester. The C9-C10 epoxidized fatty acid alkyl ester 120 is then ring opened by alcoholysis or by hydrogenation to form a C9-C10 hydroxy-functional fatty acid alkyl ester 122. By “C9-C10 hydroxy-functional” it is meant that either the C9 or the C10 carbon atoms have a pendant hydroxyl group. The other carbon atom may be substituted with an alkoxy group (i.e., for alcoholysis) or a hydrogen group (i.e., for hydrogenation). The C9-C10 hydroxy-functional fatty acid alkyl ester 122 is then reacted with an ester-reactive initiator 124 in order to form polyester polyol 126.

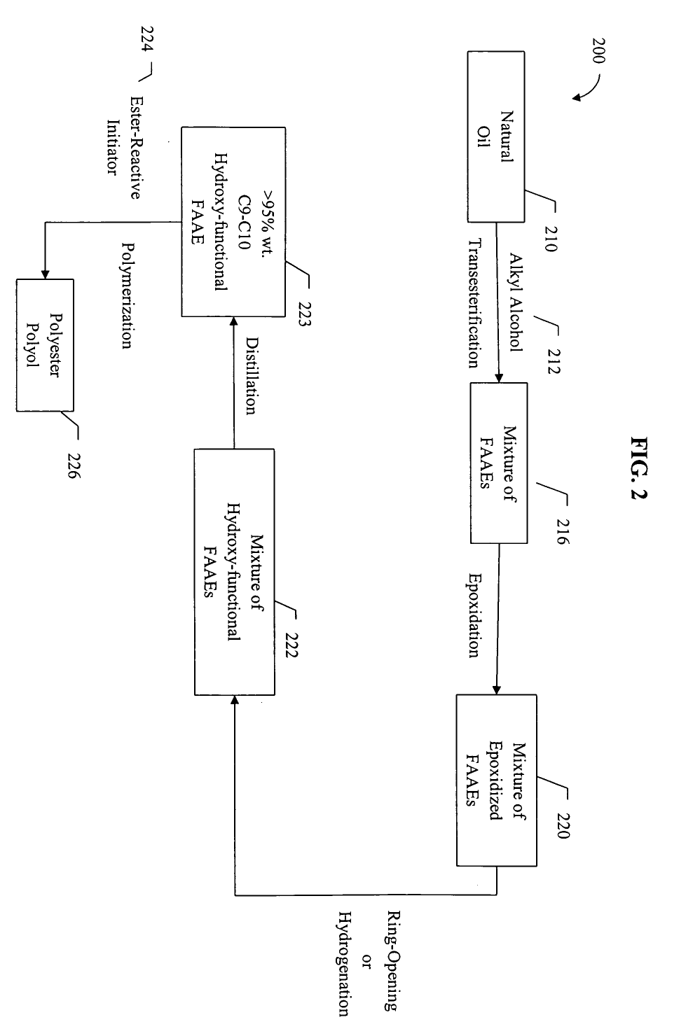

Referring now to FIG. 2, another exemplary reaction scheme 200 is shown. In process 200 a natural oil 210 is transesterified with an alkyl alcohol 212 to produce a mixture comprising C9-C10 monounsaturated fatty acid alkyl esters 216. The C9-C10 monounsaturated fatty acid alkyl ester 216 is then epoxidized to form a mixture comprising C9-C10 epoxidized fatty acid alkyl ester 220. By “C9-C10 epoxidized” it is meant that the epoxy oxygen bridges the C9 and C10 carbon atoms in the fatty acid alkyl ester. The mixture comprising C9-C10 epoxidized fatty acid ester 220 is then ring opened by alcoholysis or hydrogenation to form a mixture comprising C9-C10 hydroxy-functional fatty acid alkyl ester 222. By “C9-C10 hydroxy-functional” it is meant that either the C9 or the C10 carbon atoms have a pendant hydroxyl group. The other carbon atom may be substituted with an alkoxy group (i.e., for alcoholysis) or a hydrogen group (i.e., for hydrogenation). The mixture comprising C9-C10 hydroxy-functional fatty acid alkyl ester 222 is then distilled in order to form a composition 223 comprising greater than about 95% weight C9-C10 hydroxy-functional fatty acid alkyl ester. The composition 223 is then reacted with an ester-reactive initiator 224 in order to form polyester polyol 226.

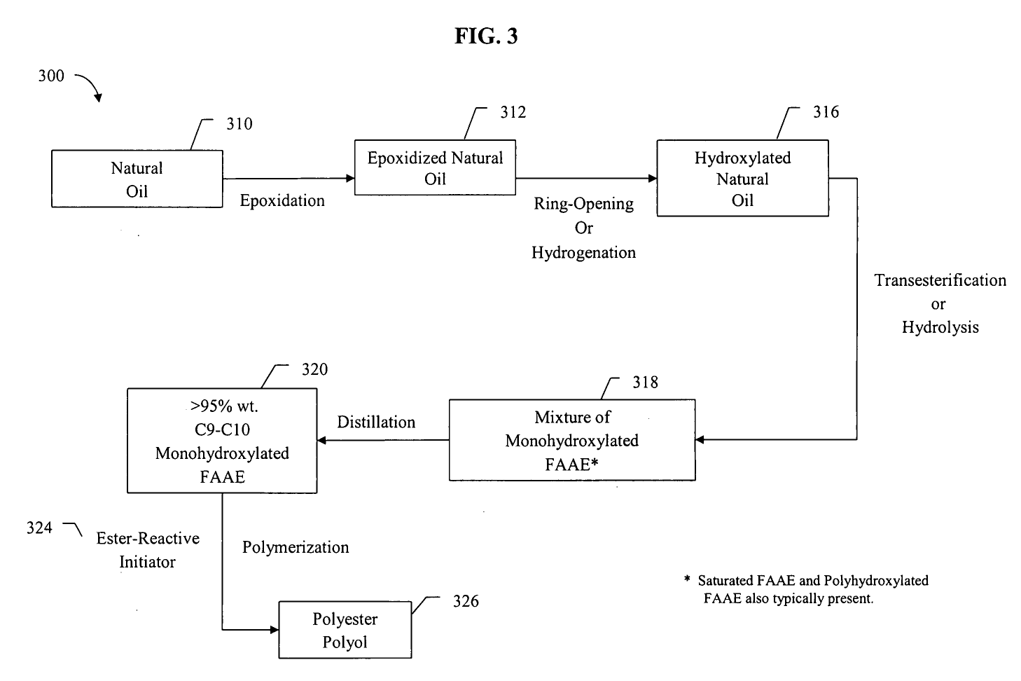

Referring now to FIG. 3, another exemplary reaction scheme 300 is shown. The natural oil 310 comprises saturated fatty acids, monounsaturated fatty acids, and polyunsaturated fatty acids in triglyceride form. In process 300 the natural oil 310 is epoxidized to form an epoxidized natural oil 312. Next, the epoxidized natural oil 312 is reacted with alcohol or hydrogen to ring-open at least a portion of the epoxide groups thereby forming a composition 316 comprising a hydroxylated natural oil. Following this, the hydroxylated natural oil 316 is transesterified or hydrolyzed to form a composition 318 comprising: (i) C9-C10 monohydroxylated fatty acid/alkyl esters; and (ii) at least one of: saturated fatty acid/alkyl esters and polyhydroxylated fatty acid/alkyl esters. The composition 318 is then distilled in order to form a composition 320 comprising greater than about 95% weight C9-C10 monohydroxylated fatty acid/alkyl ester. The C9-C10 monohydroxylated fatty acid/alkyl ester 320 is then reacted with an ester-reactive initiator 324 in order to form polyester polyol 326.

### Starting Materials:

Starting materials that are useful for preparing polyester polyols of the invention comprise greater than about 95% weight monounsaturated fatty acid/alkyl ester. By “fatty acid/alkyl ester” it is meant that the composition may include monounsaturated fatty acids, monounsaturated fatty alkyl esters, or mixtures thereof. By the term “monounsaturated” it is meant that the fatty acid/ester has one carbon-carbon double bond that is located in the main chain of the fatty acid/ester.

In many embodiments, the monounsaturated fatty acid/alkyl esters are derived from natural oils, such as vegetable oils or animal fats, by transesterification with a monohydric alcohol to produce a fatty acid alkyl ester or by hydrolysis to produce a fatty acid. In some embodiments, following transesterification, the resulting composition is distilled to yield a purified monounsaturated fatty acid alkyl ester. Following hydrolysis, the resulting composition may be distilled (e.g., at high temperature and low pressure (typically a vacuum)) or may be fractionally crystallized to yield a purified monounsaturated fatty acid.

In some embodiments, the monounsaturated fatty acid/alkyl ester is a C9-C10 monounsaturated fatty acid/alkyl ester. As used herein the term “C9-C10 monounsaturated” refers to a fatty acid/alkyl ester having one carbon-carbon double bond located between the 9^{th} and 10^{th} carbon atoms (i.e., between C9 and C10) in the alkene chain of the monounsaturated fatty acid/alkyl ester. In determining this position, the alkene chain is numbered beginning with the carbonyl carbon in the carboxyl group of the monounsaturated fatty acid/alkyl ester. In many embodiments, a C9-C10 monounsaturated fatty acid/alkyl ester may be represented by the following structure:

CH₃—(CH₂)ₙ—CH═CH—(CH₂)₇—COOR
where n is ≧0, more typically ranging from 1 to 13; and
R is hydrogen (fatty acid) or a straight or branched chain alkyl group, more typically a methyl, ethyl, propyl, butyl, and the like.

In some embodiments, the monounsaturated fatty acid/alkyl ester is a C5-C6 monounsaturated fatty acid alkyl ester. As used herein the term “C5-C6 monounsaturated” refers to a monounsaturated fatty acid/alkyl ester that has one carbon-carbon double bond located between the 5^{th} and 6^{th} carbon atoms (i.e., between C5 and C6) in the alkene chain of the monounsaturated fatty acid/alkyl ester. A C5-C6 monounsaturated fatty acid/alkyl ester may be represented by the following structure:

CH₃—(CH₂)ₙ—CH═CH—(CH₂)₃—COOR
where n is ≧0, more typically ranging from 1 to 17; and
R is hydrogen or a straight or branched chain alkyl group, more typically a methyl, ethyl, propyl, butyl, and the like.

In some embodiments, the monounsaturated fatty acid/alkyl ester is a C6-C7 monounsaturated fatty acid/alkyl ester. As used herein the term “C6-C7 monounsaturated” refers to a FAAE having one carbon-carbon double bond located between the 6^{th} and 7^{th} carbon atoms (i.e., between C6 and C7) in the alkene chain of the monounsaturated fatty acid alkyl ester. A C6-C7 monounsaturated fatty acid alkyl ester may be represented by the following equation:

CH₃—(CH₂)ₙ—CH═CH—(CH₂)₄—COOR
where n is ≧0, more typically ranging from 2 to 16; and
R is a straight or branched chain alkyl group, more typically a methyl, ethyl, propyl, butyl, and the like.

In some embodiments, the monounsaturated fatty acid alkyl ester is a C11-C12 monounsaturated fatty acid/alkyl ester. As used herein the term “C11-C12 monounsaturated” refers to a fatty acid/alkyl ester having one carbon-carbon double bond located between the 11^{th} and 12^{th} carbon atoms (i.e., between C11 and C12) in the alkene chain of the monounsaturated fatty acid/alkyl ester. A C11-C12 monounsaturated fatty acid/alkyl ester may be represented by the following structure:

CH₃—(CH₂)ₙ—CH═CH—(CH₂)₉—COOR
where n is ≧0, more typically ranging from 1 to 11; and
R is hydrogen or a straight or branched chain alkyl group, more typically a methyl, ethyl, propyl, butyl, and the like.

In some embodiments, the monounsaturated fatty acid/alkyl ester is a C13-C14 monounsaturated fatty acid/alkyl ester. As used herein the term “C13-C14 monounsaturated” refers to a fatty acid/alkyl ester having one carbon-carbon double bond located between the 13^{th} and 14^{th} carbon atoms (i.e., between C13 and C14) in the alkene chain of the monounsaturated fatty acid/alkyl ester. A C13-C14 monounsaturated fatty acid/alkyl ester may be represented by the following structure:

CH₃—(CH₂)ₙ—CH═CH—(CH₂)₁₁—COOR
where n is ≧0, more typically ranging from 1 to 9; and
R is hydrogen or a straight or branched chain alkyl group, more typically a methyl, ethyl, propyl, butyl, and the like.

Natural oils that may be used to prepare the starting compositions typically comprise at least some content of monounsaturated fatty acids that are esterified to glycerol to foam glycerides, typically triglycerides. The fatty acids typically contain chain lengths that have from about 10 to about 24 carbon atoms. Common saturated fatty acids that are present in the natural oils include lauric acid (dodecanoic acid), myristic acid (tetradecanoic acid), palmitic acid (hexadecanoic acid), stearic acid (octadecanoic acid), arachidic acid (eicosanoic acid), and lignoceric acid (tetracosanoic acid). Unsaturated fatty acids typically include monounsaturated and polyunsaturated fatty acids. Common monounsaturated fatty acids include palmitoleic acid (a C16 unsaturated acid) and oleic acid (a C18 unsaturated acid). Common polyunsaturated fatty acids include linoleic acid (a C18 di-unsaturated acid), linolenic acid (a C18 tri-unsaturated acid), and arachidonic acid (a C20 tetra-unsaturated acid).

Examples of natural oils include plant-based oils (e.g., vegetable oils) and animal fats. Preferably, the natural oil is high in monounsaturated fatty acids (e.g., oleic acid). Useful natural oil sources for C9-C10 monounsaturated fatty acids include canola oil, high oleic canola oil, tall oil, soybean oil, high oleic soybean oil, safflower oil, corn oil, sunflower oil, high oleic sunflower oil, olive oil, sesame oil, cottonseed oil, palm-based oils, peanut oil, and combinations thereof. Animal fats may also be used, for example, lard, and tallow. The plant-based oils may be natural or genetically modified vegetable oils, for example, high oleic safflower oil, high oleic soybean oil, high oleic peanut oil, and high oleic sunflower oil. Also included are microbial oils such as algal oil, including those that are genetically modified to increase yield and/or obtain selective fatty acid distributions.

Useful natural oil sources for C5-C6 monounsaturated fatty acid/alkyl esters includes meadowfoam oil which contains a twenty carbon C5-C6 monounsaturated fatty acid in glyceride form. Useful natural oil sources for C13-C14 monounsaturated fatty acids include crambe oil, fish oil, and high erucic acid rapeseed oil, which are high in erucic acid in glyceride form. Useful natural oil sources for C6-C7 monounsaturated fatty acids include coriander oil which contains an 18 carbon unsaturated fatty acid (C18:1; Δ6) in glyceride form. Useful natural oil sources for C11-C12 monounsaturated fatty acids include camelina oil which contains gondoic acid (C20:1 Δ11) at approximately 15% of the fatty acid composition.

In some embodiments the natural oil is transesterified with a monofunctional alcohol (see, FIG. 1) or hydrolyzed in order to yield alkyl esters or acids of the various fatty acids that are present in the natural oil. The resulting composition may then be distilled in order to separate the monounsaturated fatty acid/alkyl esters (e.g., methyl oleate) from the other products (e.g., saturated fatty acid alkyl esters and polyunsaturated fatty acid alkyl ester) that are present. Useful highly pure C9-C10 monounsaturated fatty acid/alkyl esters that may be manufactured this way include methyl oleate, ethyl oleate, propyl oleate, isopropyl oleate, butyl oleate, isobutyl oleate, and the like. When distillation is conducted, it is typical for the monounsaturated fatty acid/alkyl ester to have a purity of greater than about 95% weight.

In other embodiments (see, FIG. 2), the transesterification products of the natural oil are epoxidized and are then ring-opened or hydrogenated in order to provide a hydroxy-functional fatty acid/alkyl ester. This composition is then distilled in order to provide a C9-C10 hydroxy functional fatty acid/alkyl ester that has a purity of greater than about 95% weight.

In yet another embodiment, the natural oil is first epoxidized to form an epoxidized natural oil. The epoxidized natural oil is then ring-opened by reaction with an alkyl alcohol or hydrogen to form a composition comprising a hydroxylated natural oil. Following this, the hydroxylated natural oil is transesterified or hydrolyzed to form a composition comprising: (i) monohydroxylated fatty acid/alkyl esters; and (ii) at least one of: saturated fatty acid/alkyl esters and polyhydroxylated fatty acid/alkyl esters. This resulting composition is then separated to provide a composition comprising greater than about 95% weight monohydroxylated fatty acid/alkyl esters. Finally, the composition comprising greater than about 95% weight monohydroxylated fatty acid/alkyl esters is reacted with a multifunctional ester-reactive initiator compound to form a polyester polyol of the invention.

In some embodiments, the starting material comprises a natural oil that contains epoxidized fatty acids. Examples include vernolic acid, alchornoic acid, and coronaric acid.

### Epoxidation:

In some embodiments of the invention, a composition comprising C9-C10 monounsaturated fatty acid esters (e.g., methyl oleate or a natural oil containing triglycerides comprising monounsaturated fatty acids) is epoxidized and ring-opened in order to convert the double bonds that are present in the monounsaturated fatty acid esters into hydroxyl groups. The introduction of hydroxyl functionality can be accomplished by first epoxidizing at least a portion of the carbon-carbon double bonds in the monounsaturated fatty acid ester composition followed by ring-opening of the epoxide groups to form hydroxyl groups.

Epoxidation is typically accomplished by reacting the monounsaturated fatty acid ester composition with a peroxyacid under conditions that convert at least a portion of or all of the carbon-carbon double bonds to epoxide groups. Examples of peroxyacids include peroxyformic acid, peroxyacetic acid, trifluoroperoxyacetic acid, benzyloxyperoxyformic acid, 3,5-dinitroperoxybenzoic acid, m-chloroperoxybenzoic acid, and combinations thereof. In some embodiments, peroxyformic acid or peroxyacetic acid are used. The peroxyacids may be added directly to the reaction mixture, or they may be formed in-situ by reacting a hydroperoxide with a corresponding acid such as formic acid, benzoic acid, fatty acids (e.g., oleic acid), or acetic acid. Examples of hydroperoxides that may be used include hydrogen peroxide, tert-butylhydroperoxide, triphenylsilylhydroperooxide, cumylhydroperoxide, and combinations thereof. In an exemplary embodiment, hydrogen peroxide is used.

Typically, for in-situ peroxyacid formation, the amount of acid used to form the peroxyacid ranges from about 0.25 to about 1.0 moles of acid per mole of double bonds in the monounsaturated fatty acid ester, more typically ranging from about 0.45 to about 0.55 moles of acid per mole of double bonds in the monounsaturated alkyl ester. Typically, the amount of hydrogen peroxide used to form the peroxy acid is about 0.5 to about 1.5 moles of hydrogen peroxide per mole of double bonds in the monounsaturated fatty acid ester, more typically about 0.8 to about 1.2 moles of hydrogen peroxide per mole of double bonds in the monounsaturated fatty acid ester.

Typically, an additional acid component is also present in the reaction mixture. Examples of such additional acids include sulfuric acid, toluenesulfonic acid, trifluoroacetic acid, fluoroboric acid, Lewis acids, acidic clays, or acidic ion exchange resins.

Optionally, a solvent may be added to the reaction. Useful solvents include chemically inert solvents, for example, aprotic solvents. These solvents do not include a nucleophile and are non-reactive with acids. Hydrophobic solvents, such as aromatic and aliphatic hydrocarbons, are particularly desirable. Representative examples of suitable solvents include benzene, toluene, xylene, hexane, isohexane, pentane, heptane, and chlorinated solvents (e.g., carbon tetrachloride). In an exemplary embodiment, toluene is used as the solvent. Solvents may be used to reduce the speed of reaction or to reduce the number of side reactions. In general, a solvent also acts as a viscosity reducer for the resulting composition.

Subsequent to the epoxidation reaction, the reaction product may be neutralized. A neutralizing agent may be added to neutralize any remaining acidic components in the reaction product. Suitable neutralizing agents include weak bases, metal bicarbonates, or ion-exchange resins. Examples of neutralizing agents that may be used include ammonia, calcium carbonate, sodium bicarbonate, magnesium carbonate, amines, and ion-exchange resin, as well as aqueous solutions of neutralizing agents. Typically, the neutralizing agent will be an anionic ion-exchange resin. One example of a suitable weakly-basic ion-exchange resin is sold under the trade designation “LEWATIT MP-64” (from Bayer). If a solid neutralizing agent (e.g., ion-exchange resin) is used, the solid neutralizing agent may be removed from the epoxidized vegetable oil by filtration. Alternatively, the reaction mixture may be neutralized by passing the mixture through a neutralization bed containing a resin or other materials. Alternatively, the reaction product may be repeatedly washed to separate and remove the acidic components from the product. In addition, one or more of the processes may be combined in neutralizing the reaction product. For example, the product could be washed, neutralized with a resin material, and then filtered.

Subsequent to the epoxidation reaction, excess solvents may be removed from the reaction product. The excess solvents include products given off by the reaction, or those added to the reaction. The excess solvents may be removed by separation, vacuum, or other method. Preferably, the excess solvent removal will be accomplished by exposure to vacuum.

### Ring-Opening of Epoxides

After forming the epoxidized fatty acid ester composition the epoxide groups are then ring-opened to produce a hydroxyl group. In this way, the epoxidized alkyl ester is converted into a hydroxyl-functional alkyl ester. In some embodiments, the ring-opening is accomplished by reacting the epoxidized alkyl ester composition with a ring-opening nucleophile in the presence of a ring-opening acid catalyst. In other embodiments, the ring-opening is accomplished by hydrogenating the epoxide groups to produce a hydroxyl group.

Various ring-openers may be used, such as alcohols. In many embodiments the ring-opener is a monohydric alcohol. Examples include methanol, ethanol, propanol (including n-propanol and isopropanol), and butanol (including n-butanol and isobutanol), and monoalkyl ethers of ethylene glycol (e.g., methyl cellosolve, butyl cellosolve, and the like). In exemplary embodiments, the ring-opener is methanol.

The ring-opening reaction is typically conducted with an excess of ring-opener to avoid the formation of polyether oligomers. For example, in some embodiments, about 3 moles or greater of ring-opener is used per mole of epoxide. In other embodiments, about 5 moles or greater of ring-opener is used per mole of epoxide. In yet other embodiments, about 10 moles or greater of ring-opener is used per mole of epoxide.

The ring-opening reaction may be monitored using known techniques, for example, hydroxyl number titration (ASTM E1899-02), EOC titration (AOCS Cd9-57 method) or monitoring the heat removed from the exothermic reaction. As used herein “epoxy oxygen content” or “EOC” refers to the weight of epoxide oxygen in a molecule expressed as a percentage.

Upon completion of the ring-opening reaction, any unreacted ring-opener (e.g., methanol) may be removed, for example, by vacuum distillation. Unreacted methanol is not desirable in the polyester polyol because it is a monofunctional species that will end-cap the polyisocyanate.

Representative examples of ring-opening acid catalysts include Lewis or Brönsted acids. Examples of Brönsted acids include hydrofluoroboric acid (HBF₄), triflic acid, sulfuric acid, hydrochloric acid, phosphoric acid, phosphorous acid, hypophosphorous acid, boronic acids, sulfonic acids (e.g., para-toluene sulfonic acid, methanesulfonic acid, and trifluoromethane sulfonic acid), and carboxylic acids (e.g., formic acid and acetic acid). Examples of Lewis acids include aluminum halides (for example, aluminum trichloride), phosphorous halides (for example, phosphorus trichloride) and boron halides (e.g., boron trifluoride). Ion exchange resins in the protic form may also be used. In an exemplary embodiment, the ring-opening catalyst is hydrofluoroboric acid (HBF₄). The ring-opening catalyst is typically present in an amount ranging from about 0.01% weight to about 0.3% weight, more typically ranging from about 0.05% weight to about 0.15% weight based upon the total weight of the reaction mixture.

Ring-opening may also be accomplished by hydrogenating the epoxide groups to produce hydroxyl groups. Hydrogenation of epoxidized fatty acid esters is described, for example, in U.S. Pat. No. 3,778,465 (Barnstorf).

After ring-opening, the hydroxyl-functional fatty acid alkyl ester may be distilled according to known techniques in order to increase the purity of the hydroxyl-functional alkyl ester.

### Polymerization

After synthesis of the hydroxyl-functional alkyl ester, the hydroxyl-functional alkyl ester is reacted with an initiator molecule (i.e., a multifunctional ester-reactive compound) to produce a polyester polyol of the invention. The multifunctional ester-reactive compound contains two or more reactive groups that are capable of reacting with ester groups that are present on the hydroxyl-functional fatty acid alkyl ester. In many embodiments, the initiator compound has the structure:

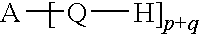

where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines

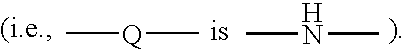

Examples of initiators include polyols, polyamines, and aminoalcohols.

Exemplary polyol initiators include neopentylglycol; 1,2-propylene glycol; 1,3-propane diol, trimethylolpropane; pentaerythritol; sorbitol; sucrose; glycerol; alkanediols such as 1,6-hexanediol; 2,5-hexanediol; 1,4-butanediol; 1,4-cyclohexane diol; ethylene glycol; diethylene glycol; triethylene glycol; tetraethylene glycols, and other polyetheyleneglycols, 9(1)-hydroxymethyloctadecanol, 1,4-bishydroxymethylcyclohexane, Dimerol alcohol (36 carbon diol available from Henkel Corporation); bisphenol A, hydrogenated bisphenol; 1,2,6-hexanetriol; ethanolamine; diethanolamine; triethanolamine; any of the aforementioned where at least one of the alcohol or amine groups present therein has been reacted with ethylene oxide or propylene oxide; and mixtures thereof. Also useful as initiators are natural oil based polyols such as those produced by epoxidation and ring-opening of natural oils, for example, vegetable oils. Exemplary natural oil based polyols are described in U.S. Pat. Nos. 6,573,354; 6,107,433; 6,433,121; 6,686,435; and U.S. Patent Publication Nos. 2006/0264524; and 2006/0041157.

In some embodiments, the polyol initiators comprise hydroxylated fatty acids that have been esterified with polyalcohols.

Polymerization of the initiator with the starting composition is typically performed until little or no esters of the starting composition are present in the final product.

The use of multifunctional initiators (as described above) along with the control of the ratio of the initiator to the starting composition allows control of the molecular weight and viscosity of the resulting polyol.

Exemplary polyamine initiators include ethylene diamine; neopentyldiamine, 1,6-diaminohexane; bisaminomethyltricyclodecane; bisaminocyclohexane; diethylene triamine; bis-3-aminopropyl methylamine; and triethylene tetramine.

Exemplary aminoalcohols initiators include ethanolamine, diethanolamine, and triethanolamine.

Other useful compounds that may be used as initiators include, for example, polyols, polyamines or aminoalcohols described in U.S. Pat. Nos. 4,216,344; 4,243,818 and 4,348,543 and British Pat. No. 1,043,507.

Preferably, the initiator is selected from the group consisting of neopentylglycol; trimethylolpropane; pentaerythritol; sorbitol; sucrose; glycerol; 1,2-propylene glycol; 1,3-propanediol, 1,6-hexanediol; 2,5-hexanediol; 1,6-hexanediol; 1,4-cyclohexane diol; 1,4-butanediol; ethylene glycol; diethylene glycol; triethylene glycol; polyethylene glycol, bis-3-aminopropyl methylamine; ethylene diamine; diethylene triamine; 9(1)-hydroxymethyloctadecanol; 1,4-bishydroxymethylcyclohexane; dimerol alcohol; hydrogenated bisphenol; 1,2,6-hexanetriol; any of the aforementioned where at least one of the alcohol or amine groups present therein has been reacted with ethylene oxide or propylene oxide; or mixtures thereof.

Most preferably the initiator is trimethylolpropane, glycerol, pentaerythritol, sucrose, sorbitol, an ethoxylated glycerol, propoxylated glycerol, ethoxylated pentaerythritol, propoxylated pentaerythritol, or mixtures thereof.

Polyester polyols of the invention may be synthesized according to two general reaction sequences. In a first sequence, the hydroxyl-functional alkyl ester and the initiator are reacted with one another directly. In a second reaction sequence, the hydroxyl-functional alkyl ester is pre-reacted with itself, and the resulting polymerized hydroxy-functional alkyl ester is then reacted with the initiator to form the polyester polyol of the invention.

In many embodiments, the polyester polyol of the invention is formed by reacting an initiator with an excess of a hydroxyl-functional fatty acid alkyl ester. The ester groups of the hydroxyl-functional fatty acid alkyl ester react with the ester-reactive groups of the initiator. This reaction results in the formation of an ester or amide group, which couples the initiator to hydroxyl-functional fatty acid alkyl esters. The pendant hydroxyl group on the coupled hydroxyl-functional fatty acid/alkyl esters may then react with an ester group on another molecule of hydroxyl-functional fatty acid/alkyl ester thereby resulting in the formation of ester groups that couple the molecules together. Continued polymerization of the hydroxyl-functional fatty acid/alkyl esters results in the formation of polyester segments extending from the initiator molecule. Typically, the polyester segments contain a terminal hydroxyl-functional fatty acid/alkyl ester, which provides hydroxyl functionality to the polyester polyol.

Typically, the hydroxyl-functional fatty acid/alkyl ester and the initiator are heated to a desired reaction temperature, for a desired reaction time. In many embodiments, the reaction is conducted under vacuum and in the presence of a catalyst. Useful catalysts include, for example, tin, titanium, enzyme catalyst (e.g., lipase), carbonate catalyst (e.g., K₂CO₃, NaHCO₃), alkali metal alkoxides (e.g., NaOMe, KOMe, KOtBu) or combinations thereof. Acid catalyst may also be used, but may result in competing dehydration reactions.

The reaction temperature that is employed typically ranges from about 140° C. to about 300° C. when using a tin, titanium, or alkali metal-based catalyst. Preferably, the reaction temperature is at least about 150° C., more preferably at least about 180° C., most preferably at least about 190° C. Preferably, the reaction temperature is about 250° C. or less, more preferably at 220° C. or less, and most preferably about 210° C. or less. Enzymes usually require temperatures from room temperature up to about 100° C.

The reaction time typically ranges from about 10 minutes to about 24 hours. Preferably, the reaction time ranges from about 15 minutes, more typically about 30 minutes, more typically about 1 hour to preferably about 12 hours, more typically about 9 hours and most typically about 5 hours.

In many embodiments, the reaction is carried out under a vacuum. Typically, the vacuum is at least about 100 torr, more preferably at least about 50 torr, and most preferably at least about 20 torr.

In a preferred embodiment, the hydroxyl-functional alkyl ester is placed in the reactor under vacuum at the reaction temperature for a period of time sufficient to polymerize a substantial amount of the hydroxyl-functional alkyl ester (e.g., at least about 10 percent of the ester groups of the hydroxyl-functional alkyl ester have undergone polymerization) and subsequently the initiator is added to form the polyester polyol. Generally, when a tin catalyst is employed, the amount of catalyst is at least about 100 ppm to at most about 2500 ppm by weight of tin to the total reaction mixture. Preferably, the amount of tin catalyst is at least about 250 ppm, more preferably at least about 500 ppm and most preferably at least about 1000 ppm to preferably at most about 2000 ppm, more preferably at most about 1500 ppm. The tin catalyst may be any suitable tin catalyst such as those known in the art. Exemplary tin catalysts include tin (II) octanoate, tin (II) 2-ethylheptanoate, dibutyl tin (IV) dilaurate, and other tin catalysts which are similarly functionalized. Preferably the tin catalyst is tin (II) octanoate, tin (II) 2-ethylheptanoate, dibutyl tin (IV) dilaurate or combination thereof.

Generally, when a titanium catalyst is employed, the amount of catalyst is at least about 100 ppm to at most about 2500 ppm by weight of titanium to the total reaction mixture. Preferably, the amount of titanium catalyst is at least about 250 ppm, more preferably at least about 500 ppm and most preferably at least about 1000 ppm to preferably at most about 2000 ppm, more preferably at most about 1500 ppm. The titanium catalyst may be any suitable titanium catalyst such as those known in the art. Exemplary titanium catalysts include titanium tetraisopropoxide, titanium tetraisobutoxide, or any appropriately functionalized titanium (IV) alkoxide. Preferably the titanium catalyst is titanium tetraisopropoxide.

The ratio of ester groups in the hydroxyl-functional alkyl ester to ester-reactive groups in the initiator typically ranges from about 1:1 (e.g., if the initiator is 1 mole of trimethylolpropane, the amount of hydroxyl-functional fatty acid alkyl ester is 3 moles) to about 100:1. In some embodiments, the ratio is about 2:1 or greater, more typically about 5:1 or greater, even more typically about 7:1 or greater, and most typically about 10:1 or greater. In some embodiments, the ratio is about 50:1 or less, more typically about 25:1 or less, and most typically about 20:1 or less.

The molecular weight of the polyester polyol may be controlled, for example, by controlling the molar ratio of the hydroxyl-functional fatty acid/alkyl ester to the initiator. More specifically, as the molar ratio of the hydroxyl-functional fatty acid/alkyl ester to the initiator increases, the molecular weight of the polyester polyol increases (assuming that the reaction is brought to completion). In many embodiments, the molar ratio of the hydroxyl-functional fatty acid/alkyl ester to the initiator ranges from about 1 to about 100, more typically about 3 to about 25.

In many embodiments the polyester polyol of the invention can be represented by the structure shown below.

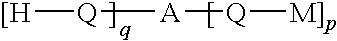

where:
A is residue of the ester-reactive initiator;
p is ≧1;
q is ≧0;
(p+q) is 2 or greater;
-Q- is selected from —O— or

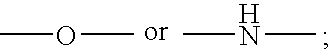

at least 95% by weight of M is selected from:

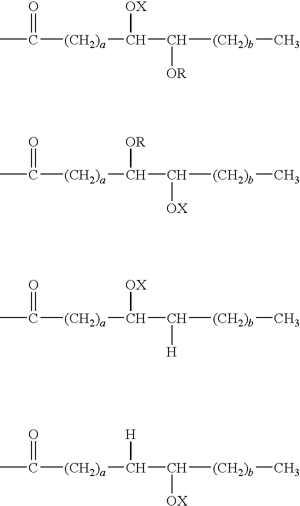

where a is >0, more typically 1 to 11;
b is ≧0, more typically 1 to 13;
X is H or M; and
R is a straight or branched chain alkyl group, for example, methyl, ethyl, propyl, butyl, and the like.

In exemplary embodiments of the invention b is 7; Q is 0; R is methyl; p is 3 to 6.

### Properties of the Polyester Polyol:

Polyester polyols of the invention typically have a number average hydroxyl functionality (Fn) that ranges from about 1.5 to about 10. Number average hydroxyl functionality refers to the average number of pendant hydroxyl groups (e.g., primary, secondary, or tertiary hydroxyl groups) that are present on a molecule of the polyester polyol. In some embodiments, the polyester polyols have a number average hydroxyl functionality (Fn) that ranges from about 2 to about 8. In some embodiments, the polyester polyols have a number average hydroxyl functionality (Fn) that ranges from about 2.5 to about 3.5. Polyols having a Fn ranging from about 2.5 to about 3.5 are desirable for use in flexible foams such as flexible slabstock foams. In some embodiments, the polyester polyol has a functionality of about 3.5 or greater, for example, about 3.5 to about 8. Polyester polyols with a Fn much greater than 3 may be useful, for example, in the production of rigid foams. In some embodiments, the polyester polyol has a Fn of about 2.5 or less, for example, about 1.5 to about 2.5. Polyester polyols having a Fn of about 2.5 or less may be useful, for example, in the formulation of polyurethane coatings, polyurethane adhesives, polyurethane sealants, and polyurethane elastomers.

In some embodiments, the polyester polyol has a hydroxyl number (OH number) that ranges from about 20 to about 500 mg KOH/g, or from about 25 to about 150 mg KOH/g. Hydroxyl number indicates the number of reactive hydroxyl groups available for reaction. It is expressed as the number of milligrams of potassium hydroxide equivalent to the hydroxyl content of one gram of the sample.

In some embodiments, the polyester polyol is a triol (i.e., Fn of 3) having a hydroxyl number in the range of about 28 mg KOH/g to about 60 mgKOH/g. Such triols are desirable because they may be used in the production of flexible polyurethane formulations where the polyester polyol replaces at least a portion of petroleum-derived triols that are typically used in such formulations. For example, in some embodiments, the polyester polyol replaces at least a portion of a petroleum-derived triol having a molecular weight of about 3000 grams/mole and a hydroxyl number of about 56 that is used in flexible slabstock formulations.

In some embodiments, the polyester polyol has a low acid value. Acid value is equal to the number of milligrams of potassium hydroxide (KOH) that is required to neutralize the acid that is present in one gram of a sample of the polyol (i.e., mg KOH/gram). A high acid value is undesirable because the acid may neutralize the amine catalyst causing a slowing of the foaming rate. In some embodiments, the polyester polyol has an acid value that is less than about 5 (mg KOH/gram), for example, less than about 4 (mg KOH/gram), less than about 3 (mg KOH/gram), less than about 2 (mg KOH/gram), or less than about 1 (mg KOH/gram). In exemplary embodiments, the acid value is less than about 1 (mg KOH/gram), for example, less than about 0.5 (mg KOH/gram), or from about 0.1 to about 0.5 (mg KOH/gram).

In some embodiments, the number average molecular weight (i.e. Mn) of the polyester polyol is about 1000 grams/mole or greater, for example, about 1100 grams/mole or greater, about 1200 grams/mole or greater, about 1300 grams/mole or greater, about 1400 grams/mole or greater, or about 1500 grams/mole or greater. In some embodiments, the Mn is less than about 10000 grams/mole, for example, less than about 6000 grams/mole, less than about 3000 grams/mole, or less than about 2000 grams/mole. In some embodiments, the Mn ranges from about 1000-10000 grams/mole, for example, about 1200-8000 grams/mole, about 1300-6000 grams/mole, about 1500-4000 grams/mole, or about 1800-3000 grams/mole. Number average molecular weight may be measured, for example, using light scattering, vapor pressure osmometry, end-group titration, and colligative properties.

Typically, the polyester polyols of the invention have a Mn molecular weight that is very nearly equal to the Mw molecular weight. Accordingly, the polydispersity (Mn/Mw) of the polyester polyols of the invention is about 1 to 4.

Polyester polyols of the invention have a viscosity at 25° C. that typically ranges from about 0.5 to about 20 Pa·s, for example, from about 0.5 to about 10 Pa·s, or from about 0.5 to about 5 Pa·s.

In some embodiments, the polyester polyol has few, if any, residual double bonds. This is particularly true if the polyester polyol is prepared from a fully epoxidized natural oil or fatty acid ester. One measure of the amount of double bonds in a substance is its iodine value (IV). The iodine value for a compound is the amount of iodine that reacts with a sample of a substance, expressed in centigrams iodine (I₂) per gram of substance (cg I₂/gram). In some embodiments, the polyester polyol has an iodine value that is less than about 50, for example, less than about 40, less than about 30, less than about 20, less than about 10, or less than about 5.

### Polymers

In another aspect the invention provides polymers (e.g., polyesters, polyurethanes, and polycarbonates) prepared from the polyester polyols of the invention.

In an exemplary embodiment, the polymers are polyurethanes that comprise the reaction product of (a) a polyisocyanate; and (b) a polyester polyol of the invention. Polyester polyols of the invention are useful in the preparation of polyurethanes, for example, slabstock polyurethane foams or molded polyurethane foams. In some embodiments, the polyurethane foam comprises the reaction product of: (a) a polyisocyanate; and (b) an active-hydrogen containing composition comprising a polyester polyol of the invention.

The hydroxyl groups of the polyester polyol chemically react with the isocyanate groups of the polyisocyanate to form the urethane linkages in the resulting polyurethane foam. Thus, the polyester polyol is chemically incorporated into the polyurethane polymer.

The amount of polyester polyol included in the active hydrogen-containing composition may be selected based upon the desired performance of the foam. For example, in some embodiments, the active-hydrogen containing composition may comprise from about 10% to about 100% weight of the polyester polyol, for example, about 10% to about 60% weight polyester polyol, or about 15% to about 40% weight polyester polyol.

In some embodiments, the active-hydrogen containing composition comprises a polyester polyol and a petroleum-derived polyol. For example, in some embodiments, the active-hydrogen containing composition comprises about 10% to about 90% weight polyester polyol and about 10% to about 90% weight petroleum-derived polyol. In some embodiments, the active-hydrogen containing composition comprises about 10% to about 60% weight polyester polyol and about 40% to about 90% weight petroleum-derived polyol. In other embodiments, the active-hydrogen containing composition comprises about 15% to about 40% weight polyester polyol and about 60% to about 85% weight petroleum-derived polyol.

In some embodiments, the polyurethane foam is a flexible foam and the petroleum-derived polyol is a triol, for example, having an average of about 2.7 to about 3.1 hydroxyl groups per molecule. In a specific embodiment, the triol has a weight average molecular weight (Mw) of about 3000 grams/mole to about 3500 grams/mole. Representative examples of commercially available petroleum-derived triols include those available under the trade designations ARCOL F3040, ARCOL F3022, and ARCOL 3222 (from Bayer), PLURACOL 1385 and PLURACOL 1388 (from BASF), VORANOL 3322, VORANOL 3010, VORANOL 3136, and VORANOL 3512A (from Dow).

In other embodiments, the polyurethane foam is a molded foam and the molecular weigh of the polyol ranges from about 3000 to about 6000 grams/mole. Representative examples of commercially available petroleum-derived polyols for use in molded foams include VORANOL 6340 (from Dow) and MULTRANOL 3901 (from Bayer).

### Polyisocyanates

Representative examples of useful polyisocyanates include those having an average of at least about 2.0 isocyanate groups per molecule. Both aliphatic and aromatic polyisocyanates can be used. Examples of suitable aliphatic polyisocyanates include 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4- and/or 4,4′-diphenylmethane diisocyanate (H₁₂MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (PMDI), and the like. Derivatives and prepolymers of the foregoing polyisocyanates, such as those containing urethane, carbodiimide, allophanate, isocyanurate, acylated urea, biuret, ester, and similar groups, may be used as well.

The amount of polyisocyanate preferably is sufficient to provide an isocyanate index of about 60 to about 120, preferably about 70 to about 110, and, in the case of high water formulations (i.e., formulations containing at least about 5 parts by weight water per 100 parts by weight of other active hydrogen-containing materials in the formulation), from about 70 to about 90. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active hydrogen atoms.

### Polyurethane Catalysts

Examples of useful polyurethane catalysts include tertiary amine compounds and organometallic compounds. Specific examples of useful tertiary amine compounds include triethylenediamine, N-methylmorpholine, N-ethylmorpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, bis(2-dimethylaminoethyl)ether, and the like. Tertiary amine catalysts are advantageously used in an amount from about 0.01 to about 5, preferably from about 0.05 to about 2 parts per 100 parts by weight of the active hydrogen-containing materials in the formulation.

Specific examples of useful organometallic catalysts include organic salts of metals such as tin, bismuth, iron, zinc, and the like, with the organotin catalysts being preferred. Suitable organotin catalysts include dimethyltindilaurate, dibutyltindilaurate, stannous octoate, and the like. Other suitable catalysts are taught, for example, in U.S. Pat. No. 2,846,408, which is hereby incorporated by reference. Preferably, about 0.001 to about 1.0 parts by weight of an organometallic catalyst is used per 100 parts by weight of the active hydrogen-containing materials in the formulation. Blends of catalysts may also be used.

### Blowing Agents

The blowing agent generates a gas under the conditions of the reaction between the active hydrogen compound and the polyisocyanate. Suitable blowing agents include water, liquid carbon dioxide, acetone, methylene chloride, and pentane, with water being preferred.

The blowing agent is used in an amount sufficient to provide the desired foam density and IFD. For example, when water is used as the only blowing agent, from about 0.5 to about 10, preferably from about 1 to about 8, more preferably from about 2 to about 6 parts by weight, are used per 100 parts by weight of other active hydrogen-containing materials in the formulation.

### Other Additives

Other additives that may be included in the formulation include surfactants, catalysts, cell size control agents, cell opening agents, colorants, antioxidants, preservatives, static dissipative agents, plasticizers, crosslinking agents, flame retardants, and the like.

Examples of useful surfactants include silicone surfactants and the alkali metal salts of fatty acids. The silicone surfactants, e.g., block copolymers of an alkylene oxide and a dimethylsiloxane, are preferred, with “low fog” grades of silicone surfactants being particularly preferred.

In some cases, a static dissipative agent may be included in the formulation during foam preparation, or used to treat the finished foam. Useful examples include non-volatile, ionizable metal salts, optionally in conjunction with an enhancer compound, as described in U.S. Pat. Nos. 4,806,571, 4,618,630, and 4,617,325. Of particular interest is the use of up to about 3 weight percent of sodium tetraphenylboron or a sodium salt of a perfluorinated aliphatic carboxylic acid having up to about 8 carbon atoms.

### Manufacturing of Polyurethane Foams

Polyurethane foams of the invention can be manufactured using known techniques for producing conventional slabstock (i.e., free-rise) and molded foams. In slabstock processes, the polyurethane reactants are mixed together and are poured onto a conveyor where the reacting mixture rises against its own weight and cures to form a slabstock bun having a nominal rectangular cross-section. The resulting slabstock bun can be cut into the desired shape to suit the end-use. In a molded foam process the reactants are mixed and dispensed into a mold where they react to fill the mold and assume the shape of the mold cavity. After the molded foam is cured, the mold is opened and the molded polyurethane article is removed.

Slabstock polyurethane foams can be manufactured using conventional slabstock foaming equipment, for example, commercial box-foamers, high or low pressure continuous foam machines, crowned block process, rectangular block process (e.g., Draka, Petzetakis, Hennecke, Planiblock, EconoFoam, and Maxfoam processes), or verti-foam process. In some embodiments, the slabstock foam is produced under reduced pressure. For example, in variable pressure foaming (VPF), the complete conveyor section of the foaming machine is provided in an airtight enclosure. This technique allows for the control of foam density and the production of foam grades that may otherwise be difficult to produce. Details of such slabstock foaming processes are reported, for example, in Chapter 5 of Flexible Polyurethane Foams, edited by Herrington and Hock, (2^{nd} Edition, 1997, Dow Chemical Company).

In some instances, it is desirable to post-cure the foam after initial forming (and demolding in the case of molded foam) to develop optimal physical properties. Post-curing may take place under ambient conditions, for example, for a period of about 12 hours to 7 days; or at elevated temperature, for example, for a period of about 10 minutes to several hours.

The foams can be used in a variety of applications, for example, they may be incorporated into seat components (e.g. seat cushions, seat backs, arm rests, and the like) for use in motor vehicles, bedding (mattresses) or furniture.

The invention will be further illustrated with reference to the following examples which are intended to aid in the understanding of the present invention, but which are not to be construed as a limitation thereof.

### EXAMPLES

### Materials

High Oleic Sunflower Oil comprising >80% by weight units derived from oleic acid, available from Cargill, Inc.
Methyl oleate (>95% by weight pure) available from Nu-Chek Prep (Elysian Minn.)
Methanol: anhydrous grade, from EMD Chemicals
Sodium methoxide: 95% powder, from Sigma-Aldrich
Hydrogen peroxide, 30% solution, from VWR international
Glacial Acetic Acid, from EMD Chemicals
Toluene, 99.5%, from EMD Chemicals
Amberlite-1R-120H, ion-exchange resin, from Sigma-Aldrich
Fluoroboric Acid, 48% aqueous solution, from EMD Chemicals
Lewatit-64, ion-exchange resin, from Sybron
Trimethylolpropane (TMP), from POLIOLI.S.P.A
FASCAT (R)-4350, from ATOFINA.
ARCOL F-3022 a petroleum derived, 3000 number average molecular weight (Mn) triol with a hydroxyl number of approximately 54.3 mg KOH/gram, an acid number of 0.03 mg KOH/gram, and a number average hydroxyl functionality of 3, available from Bayer.
EPH-140 a silicone surfactant available from Goldschmidt
BL-11—an amine catalyst available from Air Products
Tin K29—a tin catalyst available from Goldschmidt
TDI—Toluene diisocyanate available from BASF

### Test Procedures:

Hydroxyl value was measured using ASTM E 1899-97, except that a mixture of 50% acetonitrile and 50% toluene was used as the solvent.
Acid Value was measured according to IUPAC method 2.201.
Epoxide oxygen content (EOC) was measured using AOCS Cd9-57 method.
Viscosity was measured using a AR 2000ex Rheometer available from TA Instruments. The measurement conditions were as follows: gap distance of 55 μm, cone type plate, 40 mm plate diameter, 2 degree plate angle, and temperature of 25° C.
Number average molecular weight (Mn) was measured by GPC on a Waters system, with 5 columns in series. The columns were Phenogel 5-50A 300×7.8 mm, 5-100A 300×7.8 mm, 5-10³A 300×7.8 mm, 5-10⁴A 300×7.8 mm, and 5-Linear/Mixed, 50×7.8 mm. A temperature of 30° C. and flow rate of 1 ml/minutes were used. The following materials were used as molecular weight standards: Arcol LHT-240 (MW 700), Soybean oil (MW 874), Epoxidized soybean oil (MW 940), Acclaim 2200 (MW 2008), Multranol 3400 (MW 3000) and Acclaim 8200 (MW 7685).

### Example 1

### Preparation of Polyester Polyol from Methyl Oleate

### Step 1: Epoxidation of Methyl Oleate

Methyl oleate (100 parts) was epoxidized using 30% hydrogen peroxide (54.68 parts), catalyzed by Amberlite IR-120H (16.85 parts) and acetic acid (10.11 parts). Toluene (47.90 parts) was added in order to improve the miscibility between the fatty acid methyl esters and the hydrogen peroxide. The epoxidation was carried out at 70° C. for 9 hours. The product was then washed multiple times with water until the pH of the aqueous phase was approximately 7. The epoxidized methyl oleate was dried at 90° C. under reduced pressure (<3 Torr).

### Step 2: Ring-Opening of Epoxidized Methyl Oleate with Methanol

The epoxide rings in the epoxidized methyl oleate (100 parts) were ring-opened using methanol (100.18 parts). The molar ratio of methanol to epoxide was 10:1. The ring-opening reaction was catalyzed with 48% fluoroboric acid (HBF₄; 0.08 parts). The ring-opening hydroxylation was carried out under refluxing conditions at 65-69° C. for 4 hours. The resulting % EOC was <0.03%. Excess methanol was then distilled out at 80° C. under high vacuum (<2 Ton). The resulting ring-opened product had the properties listed in TABLE 1-1.

TABLE 1-1

| Property | Units | Value |
|---|---|---|
| Hydroxyl | mg KOH/g | 162 |
| Number | | |
| Acid Value | mg KOH/g | 0.95 |
| Peroxide Value | meq/kg | 2.0 |
| Water Content | ppm | 120 |
| Density | g/ml | 0.931 |
| Color | <<1 | Gardner |
| Monomer | % | 96 |
| Dimer | % | 4 |
| Equivalent | — | 346 |
| Weight | | |

### Step 3: Polymerization of Hydroxylated Methyl Stearate

Hydroxylated methyl stearate (100 parts), TMP (4.3 parts), and Fascat (R)-4350 catalyst (1.04 parts) were placed in a flask that was equipped with a heating mantle, thermocouple, heat controller, and distillation condenser attached to a vacuum pump. The mixture was heated to 220° C. The TMP and Fascat melted and dissolved completely at about 150° C., and the reaction mixture became clear. The first drops of methanol from the transesterification reaction began to distill at about 190° C. The reaction mixture was maintained at 220° C. for 3 hours. A vacuum (˜50 torr) was applied and held for about 1 hour, and the vacuum was then increased to <8 torr and was held for 3-4 hours. As the amount of methanol being distilled became very low, the vacuum decreased to 1-2 torr. The product was then allowed to cool to room temperature. The resulting polyol had the properties listed in TABLE 1-2.

TABLE 1-2

| | OH# | | | | | Viscosity |
|---|---|---|---|---|---|---|
| | (mg KOH/g) | Mn | Mw | Fn | Fw | (Pa · s) |
| Polyol 1.1 | 51 | 2468 | 4318 | 2.24 | 3.93 | 8.9 |

Polyurethane foams were prepared from Polyol 1.1 using the procedure described above. The resulting polyurethane foams had the properties listed in TABLE 1-3.

TABLE 1-3

| | | |
|---|---|---|
| Polyol #1 | Arcol F- | 70 |
| (pph) | 3022 | |
| Polyol #2 | Polyol 1.1 | 30 |
| (pph) | | |
| Water | | 3.949 |
| (pph) | | |
| Silicone | EP-H-140 | 1 |
| Surfactant | | |
| (pph) | | |
| Amine Catalyst | BL-11 | 0.16 |
| (pph) | | |
| Tin Catalyst | K-29 | 0.23 |
| (pph) | | |
| TDI Index | | 105 |

| | |
|---|---|
| Foam properties | Value |
| Density (pcf) | 1.49 |
| Resiliency (%) | 33.5 |
| 25% IFD (N) | 28.24 |
| 65% IFD (N) | 51.6 |
| Support Factor | 1.83 |
| IFD (15 × 15 × 4) | 35.13 |
| (lbs/50 sq.in.) | |
| Tensile (kPa) | 90.73 |
| Elongation (%) | 133.11 |
| Tear (N/m) | 383.75 |
| Permeability (cfm) | 86 |
| 90% CS (% | 24.51 |
| loss) | |

### Example 2

### Preparation of Polyester Polyol from High Oleic Sunflower Oil (Hosfo)

### Step 1: Methanolysis of High Oleic Sunflower Oil

Methanolysis was carried out by refluxing a mixture containing methanol (43.2 parts) and high oleic sunflower oil (HOSFO, 100 parts). The molar ratio of methanol to ester bonds was 4:1. 0.3 wt % of sodium methoxide (0.43 parts) was used as catalyst for the reaction. The reaction took approximately 4 hours to reach completion. The product was then washed with water in order to remove the base catalyst and the glycerol generated during the reaction. The fatty acid methyl ester (FAME) was dried at 80° C. under high vacuum (<1 Torr).

### Step 2: Epoxidation of FAME from High Oleic Sunflower Oil

100 parts of FAME from Step 1 as epoxidized using 30% hydrogen peroxide (59.89 parts) catalyzed with Amberlite IR-120 (7.14 parts) and acetic acid (10.57 parts). Toluene (42.86 parts) was added in order to improve the miscibility between the FAMEs and the hydrogen peroxide. The epoxidation was carried out at 70° C. for 7 hours. The product was washed multiple times with water until the pH of the aqueous phase was about 7. The epoxidized FAMEs was then dried at 80° C. under high vacuum (<1 Torr).

### Step 3: Reaction of epoxidized FAMEs with methanol

100 parts of epoxidized FAME from Step 2 was ring-opened with 100.39 parts methanol. The molar ratio of methanol to epoxide groups was 10:1. The ring-opening reaction was catalyzed with 0.02 wt % of HBF₄ (0.08 parts). The ring-opening hydroxylation was carried out under refluxing conditions at 65-70° C. for 30-35 minutes. The excess methanol was then distilled off at 80° C. under high vacuum (<1 Torr). The resulting product was a light yellow, low viscosity liquid. The properties of the product are shown in TABLE 2-1.

TABLE 2-1

| Property | Units | Value |
|---|---|---|
| Hydroxyl | mg KOH/g | 155 |
| Number | | |
| Acid Value | mg KOH/g | 1.12 |
| Functionality | — | 0.97 |
| Equivalent | — | 362 |
| Weight | | |

### Step 4: Polyol Synthesis from Hydroxylated High Oleic Sunflower Oil FAMEs

### Preparation of Polyol 2.1

Polyol 2.1 was synthesized from hydroxylated FAME obtained from high oleic sunflower oil after fractional distillation to remove most of the saturated fatty acids. The distillation was carried out under high vacuum (<1 mm Hg) at 220-230° C. The hydroxylated fatty acid methyl esters obtained after fractional distillation had a hydroxyl value of 167 mgKOH/g (the mixture before distillation had a OH# of 155 mgKOH/g). Polyol 2.1 was synthesized from this material as previously described using the ratios shown in the TABLE 2-2. The properties of Polyol 2.1 are shown in TABLE 2-3.

TABLE 2-2

| | Hydroxylated | | |
|---|---|---|---|
| | FAME | Initiator | Catalyst |
| | (parts) | (parts) | (parts) |
| Polyol 2-1 | 100 | TMP | 0.52 |
| | | (4.20) | |

TABLE 2-3

| | OH# | Acid # | | | | | | Viscosity |
|---|---|---|---|---|---|---|---|---|
| | (mg KOH/g) | (mg KOH/Kg) | Mn | Mw | Fn | Fw | Mw/Mn | (Pa · s) |
| Polyol 2.1 | 59 | 1.12 | 1927 | 4007 | 1.99 | 4.13 | 2.08 | 7.9 |

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A method of preparing a polyester polyol, the method comprising the steps of:
(a) providing a composition comprising greater than about 95% weight of a monounsaturated fatty acid/alkyl ester;
(b) epoxidizing the composition comprising monounsaturated fatty acid/alkyl ester to form a composition comprising monoepoxidized fatty acid/alkyl ester;
(c) reacting the composition comprising monoepoxidized fatty acid/alkyl ester with an alcohol or hydrogen which ring-opens at least a portion of the epoxide groups to form a composition comprising a monohydroxylated fatty acid/alkyl ester; and
(d) reacting the composition comprising monohydroxylated fatty acid/alkyl ester with a multifunctional ester-reactive initiator compound according to the formula 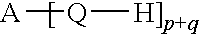
where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines 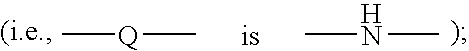
to form the polyester polyol of the invention.

2. A method of preparing a polyester polyol, the method comprising the steps of:
(a) providing a composition comprising monounsaturated fatty acid/alkyl ester;
(b) epoxidizing at least a portion of the composition comprising monounsaturated fatty acid/alkyl ester to form a composition comprising monoepoxidized fatty acid/alkyl ester;
(c) reacting the composition comprising monoepoxidized fatty acid/alkyl ester with an alcohol or hydrogen to ring-open at least a portion of the epoxide groups to form a composition comprising a monohydroxylated fatty acid/alkyl ester;
(d) fractionating the composition comprising monohydroxylated fatty acid/alkyl ester to provide a composition comprising greater than about 95% weight of monohydroxylated fatty acid/alkyl ester; and
(e) reacting the composition comprising greater than about 95% weight monohydroxylated fatty acid/alkyl esters with a multifunctional ester-reactive initiator compound according to the formula 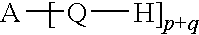
where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines 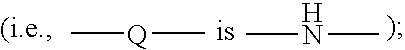
to form the polyester polyol of the invention.

3. A method of preparing a polyester polyol, the method comprising the steps of:
(a) providing a natural oil comprising saturated, monounsaturated, and polyunsaturated fatty acids in triglyceride form;
(b) epoxidizing the natural oil to form an epoxidized natural oil;
(c) reacting the epoxidized natural oil with an alcohol or hydrogen to ring-open at least a portion of the epoxide groups to form a composition comprising a hydroxylated natural oil;
(d) transesterifying or hydrolyzing the hydroxylated natural oil to form a composition comprising:
(i) monohydroxylated fatty acid/alkyl esters; and
(ii) at least one of:
saturated fatty acid/alkyl esters and
polyhydroxylated fatty acid/alkyl esters;
(e) fractionating the composition of step (d) to provide a composition comprising greater than about 95% weight monohydroxylated fatty acid/alkyl esters; and
(f) reacting the composition comprising greater than about 95% weight monohydroxylated fatty acid/alkyl esters with a multifunctional ester-reactive initiator compound according to the formula 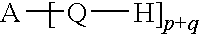
where:
A is an organic group; with the proviso that A does not contain an ester of a monofunctional alcohol;
(p+q) is an integer greater than or equal to 2; and
-Q-H are independently ester-reactive functional groups, such as alcohols (i.e., -Q- is —O—) and amines 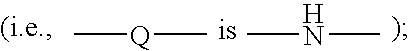
to form the polyester polyol of the invention.

4. The method of claim 1, wherein the step of providing a composition comprising greater than about 95% weight of a monounsaturated fatty acid/alkyl ester comprises:
(a) providing a natural oil;
(b) transesterifying or hydrolyzing the natural oil to form a composition comprising:
(i) monounsaturated fatty acid/alkyl esters; and
(ii) one or more of: saturated fatty acid/alkyl esters and polyunsaturated fatty acid alkyl esters; and
(c) separating the composition of step (b) to form a composition comprising greater than about 95% weight of monounsaturated fatty acid/alkyl ester.

5. The method of claim 2, wherein the step of providing a composition comprising monounsaturated fatty acid/alkyl ester comprises:
(a) providing a natural oil; and
(b) transesterifying or hydrolyzing the natural oil to form a composition comprising:
(i) monounsaturated fatty acid/alkyl esters; and
(ii) one or more of: saturated fatty acid/alkyl esters and polyunsaturated fatty acid alkyl esters.

6. The method of any one of claim 1, wherein the monounsaturated fatty acid/alkyl ester is C9-C10 monounsaturated.

7. The method of claim 6, wherein the C9-C10 monounsaturated fatty acid/alkyl ester comprises methyl oleate, ethyl oleate, propyl oleate, isopropyl oleate, butyl oleate and isobutyl oleate.

8. The method of any one of claim 1, wherein the monounsaturated fatty acid/alkyl ester is C5-C6 monounsaturated.

9. The method of any one of claim 1, wherein the monounsaturated fatty acid/alkyl ester is C6-C7 monounsaturated.

10. The method of any one of claim 1, wherein the monounsaturated fatty acid/alkyl ester is C11-C12 monounsaturated.

11. The method of any one of claim 1, wherein the monounsaturated fatty acid/alkyl ester is C13-C14 monounsaturated.

12. The method of any one of claim 1, wherein the multifunctional ester-reactive initiator compound is a polyol, a polyamine, or an aminoalcohol.

13. The method of any one of claim 1, wherein the multifunctional ester-reactive initiator is selected from the group consisting of neopentylglycol; 1,2-propylene glycol; 1,3-propane diol, trimethylolpropane, pentaerythritol, sorbitol, sucrose, glycerol, alkanediols, 1,6-hexanediol, 2,5-hexanediol, 1,4-butanediol, 1,4-cyclohexane diol, ethylene glycol, diethylene glycol, triethylene glycol, tetraethylene glycols, polyetheyleneglycols, 9(1)-hydroxymethyloctadecanol, 1,4-bishydroxymethylcyclohexane; Dimerol alcohol, bisphenol A, hydrogenated bisphenol, 1,2,6-hexanetriol, ethanolamine, diethanolamine, triethanolamine, natural oil-based polyols, any of the aforementioned where at least one of the alcohol or amine groups present therein has been reacted with ethylene oxide or propylene oxide, and mixtures thereof.

14. The method of any one of claim 1, wherein the multifunctional ester-reactive initiator is trimethylolpropane.

15. The method of any one of claim 1, wherein the polyester polyol is a triol.

16. The method of any one of claim 1, wherein the polyester polyol has a number average functionality (Fn) ranging from about 1.5 to about 10.

17. (canceled)

18. The method of any one of claim 1, wherein the polyester polyol has a number average functionality (Fn) ranging from about 2.5 to about 3.5.

19. (canceled)

20. The method of any one of claim 1, wherein the polyester polyol has a hydroxyl number that ranges from about 25 to about 150 mg KOH/g.

21. The method of any one of claim 1, wherein the polyester polyol is a triol having a hydroxyl number ranging from about 28 to about 60 mg KOH/gram.

22. The method of any one of claim 1, wherein the polyester polyol has an acid value that is less than about 5 mg KOH/gram.

23. (canceled)

24. The method of any one of claim 1, wherein the polyester polyol has a Mn ranging from about 2000 Da to about 4000 Da.

25. The method of any one of claim 1, wherein the polyester polyol has an iodine value (IV) that is less than about 50.

26. (canceled)

27. A polyester polyol produced by the method of any one of claim 1.

28-59. (canceled)
